(19) United States
(12) Patent Application Publication
(10) Pub. No.: US 2026/0230564 A1
(43) Pub. Date: Aug. 6, 2026

(54) LIFETIME PREDICTION DEVICE, LIFETIME PREDICTION METHOD, AND NON-TRANSITORY RECORDING MEDIUM

(71) Applicant: Takeshi YAMAMOTO, Kanagawa (JP)

(72) Inventor: Takeshi YAMAMOTO, Kanagawa (JP)

(73) Assignee: ETRIA Co., Ltd., Kanagawa (JP)

(21) Appl. No.: 19/460,594

(22) Filed: Jan. 27, 2026

(30) Foreign Application Priority Data
Jan. 31, 2025 (JP) 2025-014560

(51) Int. Cl. H04N 1/00

(52) U.S. Cl. CPC H04N 1/00068; H04N 1/00042; H04N 2201/0094

(57) ABSTRACT

A lifetime prediction device includes circuitry that acquires operation information, initial information, and event information. The operation information indicates an operating status of a target object including an electronic device and a component of the electronic device. The operation information includes a characteristic value during operation of the target object and an environment value indicating an environment around the target object. The initial information includes an initial value of the characteristic value of the target object. The event information pertains to an event that has caused replacement of the target object. The circuitry predicts a remaining lifetime of the target object based on the characteristic value included in the operation information, the initial value of the characteristic value included in the initial information, and the characteristic value at the replacement of the target object.

### CROSS-REFERENCE TO RELATED APPLICATION

This patent application is based on and claims priority pursuant to 35 U.S.C. § 119(a) to Japanese Patent Application No. 2025-014560, filed on Jan. 31, 2025, in the Japan Patent Office, the entire disclosure of which is hereby incorporated by reference herein.

### BACKGROUND

### Technical Field

The present disclosure relates to a lifetime prediction device, a lifetime prediction method, and a non-transitory recording medium.

### Related Art

Techniques have been developed to predict the lifetime of components.

The lifetime of electronic devices and components included in the electronic devices varies depending on the usage environment, such as the temperature and humidity of the space in which the electronic devices and the components of the electronic devices are used.

### SUMMARY

The present disclosure described herein provides a lifetime prediction device including circuitry that acquires operation information, initial information, and event information. The operation information indicates an operating status of a target object including an electronic device and a component of the electronic device. The operation information includes a characteristic value during operation of the target object and an environment value indicating an environment around the target object. The initial information includes an initial value of the characteristic value of the target object. The event information pertains to an event that has caused replacement of the target object. The circuitry predicts a remaining lifetime of the target object based on the characteristic value included in the operation information, the initial value of the characteristic value included in the initial information, and the characteristic value at the replacement of the target object.

The present disclosure described herein provides a lifetime prediction method including acquiring and predicting. The acquiring includes acquiring operation information, initial information, and event information. The operation information indicates an operating status of a target object including an electronic device and a component of the electronic device. The operation information includes a characteristic value during operation of the target object and an environment value indicating an environment around the target object. The initial information includes an initial value of the characteristic value of the target object. The event information pertains to an event that has caused replacement of the target object. The predicting includes predicting a remaining lifetime of the target object based on the characteristic value included in the operation information, the initial value of the characteristic value included in the initial information, and the characteristic value at the replacement of the target object.

The present disclosure described herein provides a non-transitory recording medium storing a plurality of instructions which, when executed by one or more processors, causes the one or more processors to perform a lifetime prediction method. The method includes acquiring and predicting. The acquiring includes acquiring operation information, initial information, and event information. The operation information indicates an operating status of a target object including an electronic device and a component of the electronic device. The operation information includes a characteristic value during operation of the target object and an environment value indicating an environment around the target object. The initial information includes an initial value of the characteristic value of the target object. The event information pertains to an event that has caused replacement of the target object. The predicting includes predicting a remaining lifetime of the target object based on the characteristic value included in the operation information, the initial value of the characteristic value included in the initial information, and the characteristic value at the replacement of the target object.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a lifetime prediction system according to a first embodiment of the present disclosure;

FIG. 2 is a diagram illustrating a hardware configuration of a lifetime prediction device or a data storage server according to the first embodiment of the present disclosure;

FIG. 3 is a block diagram illustrating a functional configuration of a lifetime prediction device according to the first embodiment of the present disclosure;

FIG. 4 is a diagram illustrating a flow of data in a lifetime prediction device according to the first embodiment of the present disclosure;

FIG. 5 is a flowchart of a lifetime prediction method executed by a lifetime prediction device according to the first embodiment of the present disclosure;

FIG. 6 is a flowchart of a process executed by a lifetime prediction device to calculate the average lifetime of a target object according to the first embodiment of the present disclosure;

FIG. 7 is a flowchart of a process executed by a lifetime prediction device to generate a lifetime calculation model according to the first embodiment of the present disclosure;

FIG. 8 is a flowchart of a process executed by a lifetime prediction device to calculate the average lifetime of a target object according to the first embodiment of the present disclosure;

FIG. 9 is a flowchart of a process executed by a lifetime prediction device to generate a lifetime calculation model according to a second embodiment of the present disclosure;

FIG. 10 is a diagram illustrating a configuration of a lifetime prediction system according to a third embodiment of the present disclosure;

FIG. 11 is a diagram illustrating a configuration of an image forming apparatus including a lifetime prediction device according to the third embodiment of the present disclosure; and

FIG. 12 is a diagram illustrating a hardware configuration of the image forming apparatus illustrated in FIG. 11.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

### First Embodiment

### Configuration Example of Lifetime Prediction System 1

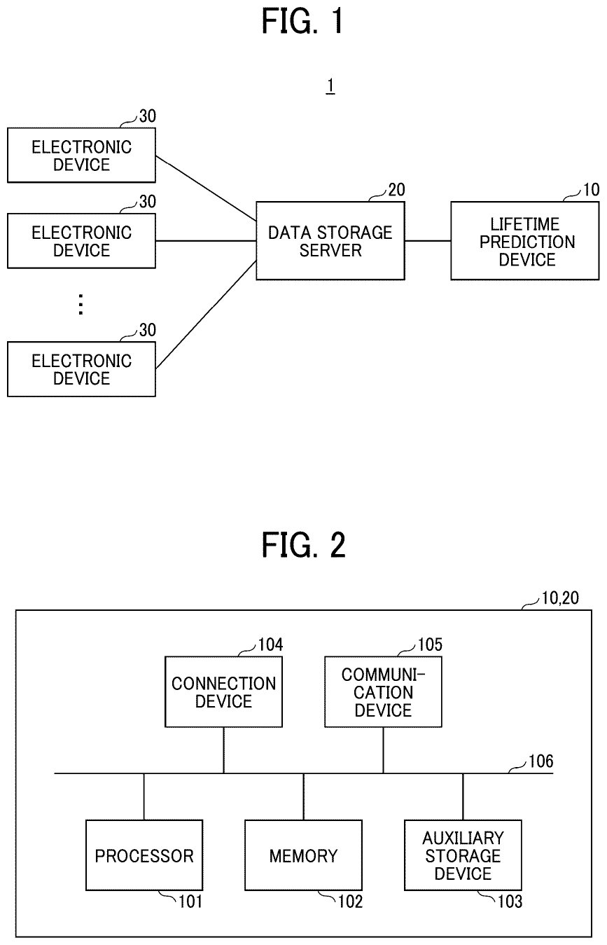

FIG. 1 is a diagram illustrating a configuration of a lifetime prediction system 1 according to a first embodiment of the present disclosure. The lifetime prediction system 1 includes a lifetime prediction device 10, a data storage server 20, and multiple electronic devices 30.

The lifetime prediction device 10 predicts the remaining lifetime of target objects, which include the electronic devices 30 and components of the electronic devices 30. The lifetime prediction device 10 and the data storage server 20 can communicate with each other via a network such as the Internet. Each of the electronic devices 30 can communicate with the data storage server 20 via a network such as the Internet.

The data storage server 20 may be a server provided on a cloud. The data storage server 20 acquires various data from the electronic devices 30 and stores the data. The lifetime prediction device 10 may have the functions of the data storage server 20. The various data may be transmitted from the electronic devices 30. Alternatively, the data storage server 20 may transmit an acquisition request to the electronic devices 30 and acquire the various data from the electronic devices 30. The electronic devices 30 may be, for example, home appliances such as refrigerators, televisions, or air conditioners, industrial products manufactured from raw materials, or manufacturing devices that manufacture industrial products.

FIG. 2 is a diagram illustrating a hardware configuration of the lifetime prediction device 10 or the data storage server 20 according to the first embodiment of the present disclosure. Each of the lifetime prediction device 10 and the data storage server 20 includes a processor 101, a memory 102, an auxiliary storage device 103, a connection device 104, a communication device 105, and a bus line 106.

The processor 101 corresponds to a central part of each of the lifetime prediction device 10 and the data storage server 20. The processor 101 controls various components to implement functions as the lifetime prediction device 10 or the data storage server 20 according to an operating system or an application program. The processor 101 includes various arithmetic devices such as a central processing unit (CPU) and a graphics processing unit (GPU). The processor 101 is a multi-core processor that includes multiple processor cores and is capable of executing multiple processes in parallel. The processor 101 reads various programs onto the memory 102 and executes the programs.

The memory 102 corresponds to a main storage portion of each of the lifetime prediction device 10 and the data storage server 20. The memory 102 includes a nonvolatile memory area and a volatile memory area. The memory 102 stores an operating system or an application program in the nonvolatile memory area.

The memory 102 stores, in the nonvolatile or volatile memory area, data necessary for the processor 101 to execute processing for controlling the components. The memory 102 uses the volatile memory area as a work area in which data is appropriately rewritten by the processor 101. The nonvolatile memory area is, for example, a read-only memory (ROM). The volatile memory area is, for example, a random-access memory (RAM).

The auxiliary storage device 103 corresponds to an auxiliary storage portion of each of the lifetime prediction device 10 and the data storage server 20. The auxiliary storage device 103 is, for example, an electrically erasable programmable read-only memory (EEPROM), a hard disk drive (HDD), or a solid-state drive (SSD). The auxiliary storage device 103 stores, for example, data used by the processor 101 in performing various processes and data generated through processing by the processor 101.

The auxiliary storage device 103 may store an application program. The various programs may be downloaded from a network via the communication device 105 and installed in the auxiliary storage device 103.

The connection device 104 is an interface (I/F) device that connects to other devices. The communication device 105 is, for example, a network interface circuit for communicating with other devices via a network.

The bus line 106 is, for example, an address bus or a data bus, which electrically connects the components or elements such as the processor 101.

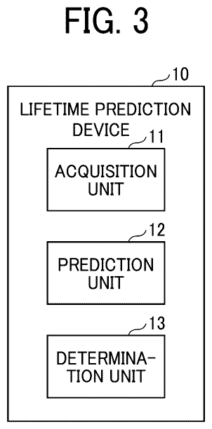

FIG. 3 is a block diagram illustrating a functional configuration of the lifetime prediction device 10 according to the first embodiment of the present disclosure. The lifetime prediction device 10 includes an acquisition unit 11, a prediction unit 12, and a determination unit 13.

The acquisition unit 11 acquires operation information indicating the operating status of a target object, which includes the electronic device 30 and a component of the electronic device 30, initial information including initial values of characteristic values of the target object, and event information pertaining to an event that has caused replacement of the target object.

The operation information includes characteristic values during operation for each target object and environmental values indicating the environment around the target object. The components are various components included in, for example, home electric appliances, industrial products, and manufacturing devices, and include consumable components. The acquisition unit 11 acquires the operation information periodically, for example, once a day.

The characteristic values may include a counter value indicating the number of times the electronic device 30 has performed a predetermined operation, a counter value indicating the energization time of the electronic device 30, and an index indicating the usage frequency based on various counter values. The index indicating the usage frequency may be, for example, a counter value for a predetermined period such as one day, but is not limited thereto.

The characteristic values may include various indices, such as the degree of wear of the consumable component. The degree of wear of the consumable component may include an index estimated from a counter value indicating the number of times the consumable component has been used, and an index indicating the degree of deterioration of the target object, which is estimated based on factors such as temperature and humidity in the environment where the electronic device 30 is installed.

The state of the environment indicates, for example, sensor values such as a temperature and a humidity in the environment in which the electronic device 30 is installed. The sensors for measuring the factors such as temperature and humidity may be disposed in the electronic device 30 or may be disposed around the electronic device 30. The initial information, including the initial values of characteristic values, includes information such as initial values of various characteristic values at the time of factory shipment of the electronic device 30, various measurement values and adjustment values acquired at the time of inspection.

The event information includes information such as the date and time of failure and anomaly occurrence of the target object, the content of maintenance, and the anomaly that has occurred. The event information includes at least information on replacement of the target object and characteristic values such as a counter value at the time of replacement. The acquisition unit 11 acquires maintenance history information not involving replacement of the target object in addition to the event information.

Information included in the operation information, the initial information, and the event information of the target object is associated with identification information for identifying the target object. The identification information is information such as an identifier for uniquely identifying a component, a component name, a component code, and a component number.

The prediction unit 12 predicts the remaining lifetime of the target object based on the characteristic values included in the operation information, the initial values of characteristic values included in the initial information, and the characteristic values at the replacement of the target object. The prediction unit 12 generates a lifetime calculation model for calculating the lifetime of the target object based on the operation information, the initial information, and the characteristic values at the replacement of the target object.

The lifetime calculation model is a model indicating correlations among the date and time of failure and anomaly occurrence for each target object included in the event information, the characteristic values at the replacement of the target object, the characteristic values of the target object that is operating as intended, which are included in the initial information and the operation information, and the lifetime of the target object.

The lifetime calculation model is modeled as a distribution of, for example, a failure rate of the target object by applying a Weibull distribution to the operation information, the initial information, and the characteristic values at the replacement of the target object. The lifetime calculation model may be expressed by an expression based on a probability density function. The lifetime calculation model may be generated by the prediction unit 12, or may be generated by another component or device.

The correlation analysis applying a Weibull distribution may be performed for each category according to factors such as the usage frequency of the electronic device 30 and environmental values, based on the respective characteristic values. The lifetime calculation model thus generated through the analysis for each category allows more appropriate determination as to whether the target object is reusable. Since each characteristic value is data of an individual target object, the prediction unit 12 can predict the remaining lifetime according to the environment of the target object.

The prediction unit 12 predicts the remaining lifetime of the target object based on the lifetime of the target object calculated using the lifetime calculation model and the average lifetime of the target object. The average lifetime of the target object is calculated based on, for example, the date and time of failure and anomaly occurrence included in the event information. The remaining lifetime of the target object is, for example, a difference between the lifetime of the target object calculated using the lifetime calculation model and the lifetime average of the target object.

The determination unit 13 determines whether the target object is reusable based on the remaining lifetime of the target object and a lifetime prediction threshold of the target object. The lifetime prediction threshold of the target object is a value set based on, for example, a standard value based on the specification of each target object.

When the predicted remaining lifetime of the target object satisfies, for example, the lifetime of the newly manufactured electronic device 30, the target object can be included in the new electronic device 30. This contributes to, for example, reduction in the amount of greenhouse gas generated by the new electronic device 30, reduction in manufacturing cost, elimination of shortage of raw materials and components of the electronic device 30.

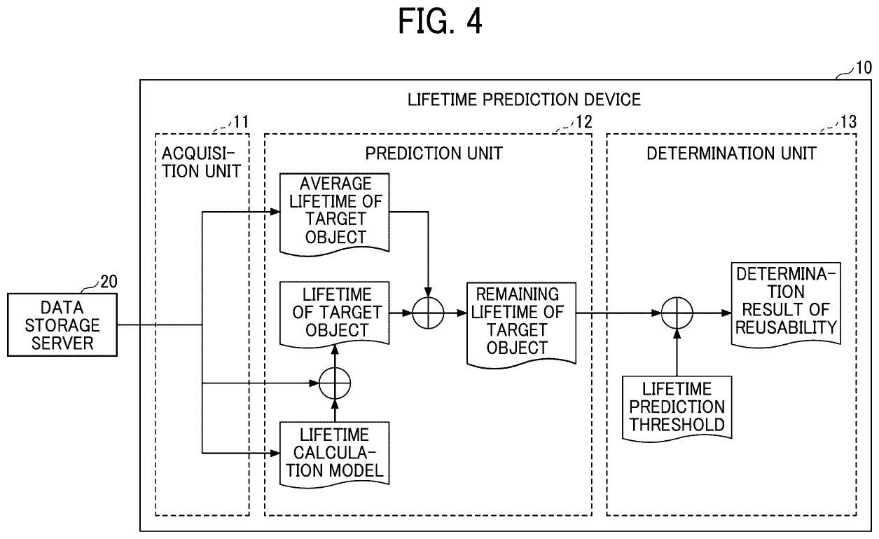

FIG. 4 is a diagram illustrating a flow of data in the lifetime prediction device 10 according to the first embodiment of the present disclosure. The acquisition unit 11 of the lifetime prediction device 10 acquires, from the data storage server 20, operation information indicating the operating status of a target object, initial information including initial values of characteristic values of the target object, and event information pertaining to an event that has caused replacement of the target object.

The prediction unit 12 calculates the average lifetime of the target object based on the date and time of failure and anomaly occurrence included in the event information. The prediction unit 12 generates a lifetime calculation model based on the operation information, the initial information, and the characteristic values at the replacement of the target object. The operation information that is used for the lifetime calculation model includes characteristic values of a target object that is operating as intended. The prediction unit 12 inputs the operation information and the initial information into the lifetime calculation model to calculate the lifetime of the target object.

The prediction unit 12 predicts the remaining lifetime of each target object by calculating a difference between the lifetime of the target object calculated using the lifetime calculation model and the average lifetime of the target object. For example, when the remaining lifetime of the target object is equal to or greater than the lifetime prediction threshold of the target object, the determination unit 13 outputs a determination result indicating that the target object is reusable. By contrast, when the remaining lifetime of the target object is less than the lifetime prediction threshold of the target object, the determination unit 13 outputs a determination result indicating that the target object is not reusable.

### Operation Flow

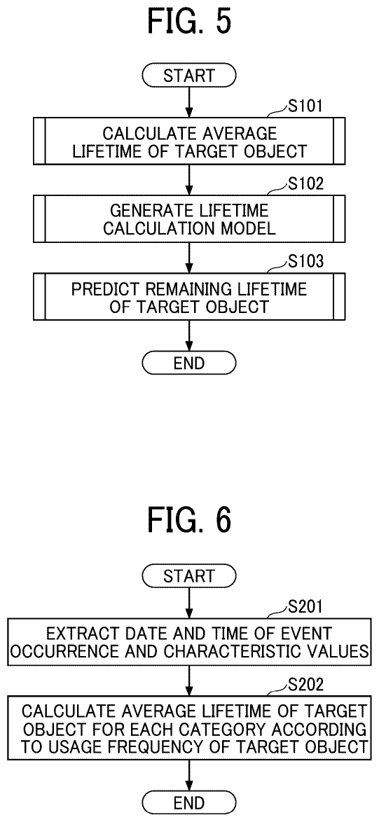

FIG. 5 is a flowchart of a lifetime prediction method executed by the lifetime prediction device 10 according to the first embodiment of the present disclosure.

In step S101, the prediction unit 12 calculates the average lifetime of a target object based on the date and time of failure and anomaly occurrence included in the event information.

In step S102, the prediction unit 12 generates a lifetime calculation model for calculating the lifetime of the target object based on the operation information, the initial information, and the characteristic values at the replacement of the target object.

In step S103, the prediction unit 12 predicts the remaining lifetime of each target object by calculating a difference between the lifetime of the target object calculated using the lifetime calculation model and the average lifetime of the target object.

The lifetime prediction method according to an aspect of the present disclosure is performed by these steps. However, the lifetime prediction method according to one aspect of the present disclosure may include other steps as appropriate depending on, for example, measurement conditions or measurement environments.

### Calculation of Average Lifetime in Step S101

FIG. 6 is a flowchart of a process executed by the lifetime prediction device 10 to calculate the average lifetime of a target object according to the first embodiment of the present disclosure.

In step S201, the prediction unit 12 extracts the date and time of failure and anomaly occurrence for each target object included in the event information and the characteristic values at the replacement of the target object. The prediction unit 12 may extract the characteristic values not only on the day of the occurrence of the event but also several days before the occurrence of the event.

In step S202, the prediction unit 12 calculates the average lifetime of the target object based on the date and time of failure and anomaly occurrence included in the event information. The prediction unit 12 calculates the average lifetime of the target object for each category according to factors such as the usage frequency of the electronic device 30 and the environmental values.

### Generation of Lifetime Calculation Model in Step S102

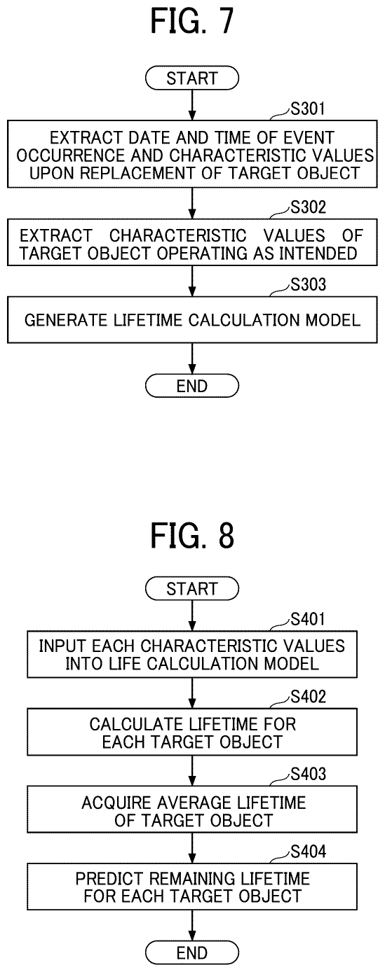

FIG. 7 is a flowchart of a process executed by the lifetime prediction device 10 to generate a lifetime calculation model according to the first embodiment of the present disclosure.

In step S301, the prediction unit 12 extracts the date and time of failure and anomaly occurrence for each target object included in the event information and the characteristic values at the replacement of the target object. The prediction unit 12 may extract the characteristic values not only on the day of the occurrence of the event but also several days before the occurrence of the event.

In step S302, the prediction unit 12 extracts characteristic values of the target object that is operating as intended, which are included in the initial information and the operation information.

In step S303, the prediction unit 12 generates a lifetime calculation model based on the extracted characteristic values and the lifetime of the target object.

### Prediction of Remaining Lifetime of Target Object in Step S103

FIG. 8 is a flowchart of a process executed by the lifetime prediction device 10 to calculate the average lifetime of a target object according to the first embodiment of the present disclosure.

In step S401, the prediction unit 12 inputs each characteristic value into the lifetime calculation model.

In step S402, the prediction unit 12 calculates the lifetime of the target object using the lifetime calculation model.

In step S403, the prediction unit 12 acquires the average lifetime of the target object calculated in step S202.

In step S404, the prediction unit 12 predicts the remaining lifetime of the target object by calculating a difference between the lifetime of the target object calculated using the lifetime calculation model and the average lifetime of the target object.

The lifetime prediction device 10 according to the present embodiment predicts the remaining lifetime of the target object using the lifetime calculation model generated based on information such as the operation information indicating the operating status of the target object and the event information pertaining to an event that has caused replacement of the target object. The operation information includes characteristic values during operation for each target object and environmental values indicating the environment around the target object.

In other words, the lifetime prediction device 10 can predict the remaining lifetime of the component by quantifying the state of the target object for each category according to factors such as the usage frequency of the electronic device 30 and the environmental values. Accordingly, the lifetime prediction device 10 can predict the remaining lifetime according to factors such as the environment in which each target object is used, and enhances the prediction accuracy of the remaining lifetime of the electronic device 30 and the components of the electronic device 30.

Further, the lifetime prediction device 10 prevents issues caused by inaccurate lifetime predictions of target objects collected for manufacturing reuse or recycle products. Such issues include discarding target objects that still have remaining life or using the target objects in recycled products when the lifetime of the target objects has already expired.

### Second Embodiment

The functional configuration of the lifetime prediction device 10 according to the present embodiment is similar to that of the lifetime prediction device 10 according to the first embodiment. Specifically, the lifetime prediction device 10 according to the present embodiment includes the acquisition unit 11, the prediction unit 12, and the determination unit 13. The lifetime prediction device 10 according to the present embodiment is different from that of the first embodiment in that the prediction unit 12 predicts the remaining lifetime of a target object using a lifetime calculation model generated by machine learning.

In the lifetime prediction device 10, a machine learning model for generating a lifetime calculation model may be stored. The machine learning model is a model that outputs a lifetime calculation model when various data such as operation information of a target object, initial information including initial values of characteristic values of the target object, and characteristic values at the replacement of the target object are input as explanatory variables. For example, the machine learning model is implemented using a neural network.

In some embodiments, the machine learning model is implemented as a convolutional neural network (CNN). In this case, the machine learning model includes an input layer, a hidden layer, and an output layer. The input layer includes multiple nodes to which various data are input. The hidden layer includes multiple intermediate layers each having multiple nodes, and the nodes of the intermediate layer on the input side are coupled to nodes of the input layer. The output layer includes nodes that output the lifetime calculation model. The nodes of the output layer are coupled to the nodes of the intermediate layer on the output side.

The machine learning model may be configured to output the lifetime calculation model using neural networks other than a CNN, or using other models such as a support vector machine (SVM) or a Bayesian network.

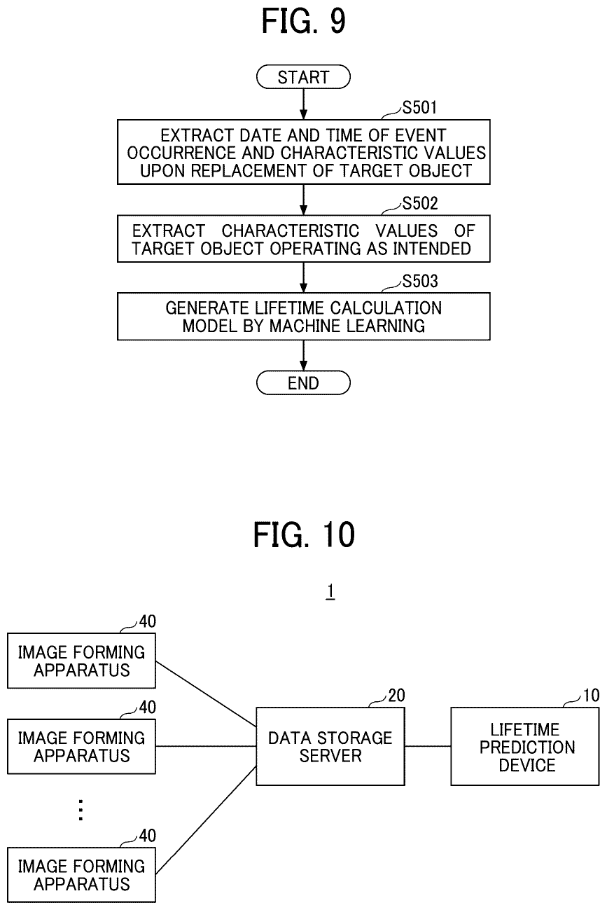

FIG. 9 is a flowchart of a process executed by the lifetime prediction device 10 to generate a lifetime calculation model according to a second embodiment of the present disclosure. In the flow illustrated in FIG. 9, the operations of steps S501 and S502 executed by the prediction unit 12 are similar to those of steps S301 and S302 illustrated in FIG. 7, and thus the description thereof will be omitted.

In step S503, the prediction unit 12 inputs various data such as the operation information of a target object, the initial information including initial values of characteristic values of the target object, and characteristic values at the replacement of the target object, as explanatory variables, into the machine-learning model, and generates a lifetime calculation model.

The processes executed by the prediction unit 12, including a process for calculating the average lifetime of a target object and a process for predicting the remaining lifetime of the target object, are similar to those described above in the first embodiment, and thus the description thereof will be omitted. The prediction unit 12 predicts the remaining lifetime of the target object based on the lifetime of the target object calculated using the lifetime calculation model generated by the machine learning model and the average lifetime of the target object.

With the lifetime calculation model generated by the machine learning model, the lifetime prediction device 10 according to the present embodiment enhances the prediction accuracy of the remaining lifetime of the electronic device 30 and the components of the electronic device 30.

### Third Embodiment

FIG. 10 is a diagram illustrating a configuration of the lifetime prediction system 1 according to a third embodiment of the present disclosure. The lifetime prediction device 10 according to the present embodiment is different from those of the first embodiment and the second embodiment in that the lifetime prediction device 10 predicts the remaining lifetime of a target object, which includes an image forming apparatus 40 and a component included in the image forming apparatus 40.

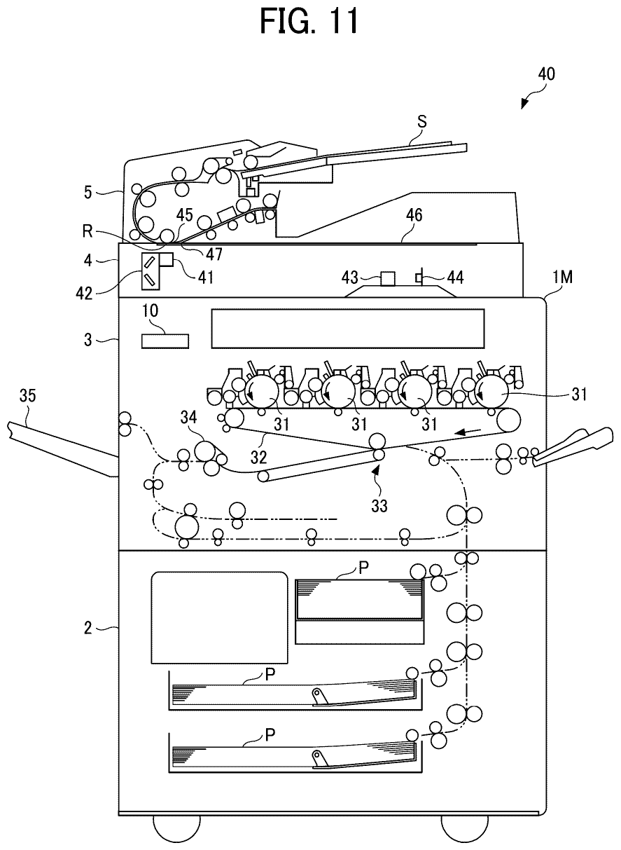

FIG. 11 is a diagram illustrating a configuration of the image forming apparatus 40 including the lifetime prediction device 10 according to the third embodiment of the present disclosure. The image forming apparatus 40 is, for example, a multifunction peripheral (MFP) that incorporates functions such as scanning, copying, printing, and facsimile transmission within a single housing. The MFP may also be referred to as a multifunction printer or multifunction product. The image forming apparatus 40 has an output function of recording a full-color image or a monochrome image on a recording sheet P based on input image data. The sheet P is a printable medium, such as printing paper of various sizes and thicknesses.

The image forming apparatus 40 may be an electrophotographic copier. The image forming apparatus 40 includes, in a housing 1M, a sheet feeder 2, an image forming device 3, a scanner 4, and the lifetime prediction device 10. An automatic document feeder (ADF) 5 is disposed on the housing 1M.

Although FIG. 11 illustrates the lifetime prediction device 10 disposed within the image forming apparatus 40, the lifetime prediction device 10 may alternatively be implemented as a separate device that is communicably connected to the image forming apparatus 40.

The sheet feeder 2 conveys the supplied sheet P to the image forming device 3. The image forming device 3 forms electrostatic latent images of different colors based on an image read by the ADF 5, for example. Toner is then applied to each electrostatic latent image to develop the electrostatic latent image into a toner image on a corresponding drum-shaped photoconductor 31. The toner image is primarily transferred to a primary transfer device 32 from each of the drum-shaped photoconductors 31, and secondarily transferred onto the sheet P by a secondary transfer device 33 located adjacent to the primary transfer device 32.

The sheet P is then conveyed to a fixing device 34 in which a full-color image is fixed onto the sheet P under heat and pressure. The sheet P bearing the fixed image is conveyed from the fixing device 34 to an output roller pair, which outputs the sheet P onto an output tray 35 located outside the housing 1M.

In the scanner 4, a first carriage 41 irradiates a document S passing over a slit glass 45 with illumination light from a light source. The light reflected from the surface (front or first side) of the document S after passing through the slit glass 45 is guided via mirrors mounted on the first carriage 41 and a second carriage 42, and is focused by an imaging lens 43 onto an imager 44 to be read as a surface (front-side) image. At a first reading position R, the surface image of the document S may be optically conjugate to the imager 44 with respect to the imaging lens 43.

An abutment member 47, disposed between the slit glass 45 and a platen glass 46, positions the document S placed on the platen glass 46 and abutted against the abutment member 47. To read the document S placed on the platen glass 46 and abutted against the abutment member 47, the first carriage 41 and the second carriage 42 move in a sub-scanning direction, which is a lateral direction in FIG. 11.

The first carriage 41 and the second carriage 42 move in the sub-scanning direction at a speed ratio of 2:1, for example. The movement of the first carriage 41 and the second carriage 42 at such a speed ratio does not change the optical path length between the surface of the document S and the imaging lens 43.

While the first carriage 41 and the second carriage 42 are moved, the light source irradiates the document S with light and the reflected light from the document S is redirected by the mirrors mounted on the first carriage 41 and the second carriage 42. The reflected light that has been redirected is focused by the imaging lens 43 and read by the imager 44.

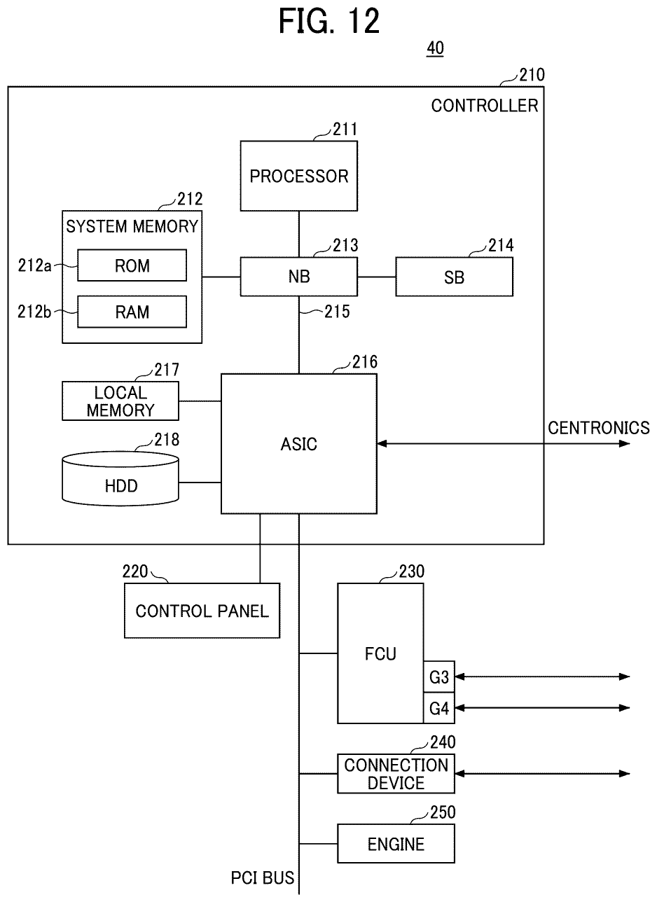

FIG. 12 is a diagram illustrating a hardware configuration of the image forming apparatus 40 illustrated in FIG. 11. As illustrated in FIG. 12, in the image forming apparatus 40, a controller 210 and an engine 250 are connected to each other via a peripheral component interface (PCI) bus. The controller 210 controls the entire image forming apparatus 40, rendering, communication, and input from an operation unit.

The engine 250 is connectable to the PCI bus, and is, for example, a print engine such as a plotter. The engine 250 includes, in addition to an engine portion, an image processing portion that performs processes such as error diffusion and gamma conversion.

The controller 210 includes a processor 211, a system memory 212, a north bridge (NB) 213, a south bridge (SB) 214, an application-specific integrated circuit (ASIC) 216, a local memory 217, and a hard disk drive (HDD) 218. The NB 213 and the ASIC 216 are connected to each other via an accelerated graphics port (AGP) bus 215. The system memory 212 includes a ROM 212a and a RAM 212b.

The processor 211 includes various arithmetic devices such as a CPU and a GPU. The processor 211 controls the overall operation of the image forming apparatus 40. The processor 211 has a chipset including the NB 213, the system memory 212, and the SB 214, and is connected to other devices via the chipset.

The NB 213 is a bridge that connects the processor 211, the system memory 212, the SB 214, and the AGP bus 215. The NB 213 includes a memory controller that controls the reading of data from or the writing of data to the system memory 212, a PCI master, and an AGP target.

The system memory 212 is used for purposes such as storing programs and data, expanding programs and data, and rendering for a printer. The system memory 212 is a storage device that includes the ROM 212a and the RAM 212b. The ROM 212a is a read-only memory used as a storage memory for programs and data. The RAM 212b is a readable and writable memory used as an expansion memory for programs and data and as a rendering memory for the printer.

The SB 214 is a bridge that electrically connects the NB 213, PCI devices, and peripheral devices. The SB 214 is connected to the NB 213 via the PCI bus, and a network I/F unit and other components are connected to the PCI bus.

The ASIC 216 is an integrated circuit (IC) dedicated to image processing and includes hardware elements for image processing. The ASIC 216 serves as a bridge that electrically connects the AGP bus 215, the PCI bus, the HDD 218, and the local memory 217. The ASIC 216 includes a PCI target, an AGP master, an arbiter (ARB) as a central processor of the ASIC 216, and a memory controller that controls the local memory 217. The ASIC 216 further includes multiple direct memory access controllers (DMACs) that perform operations such as image data rotation using hardware logic, and a PCI unit that transfers data between the engine 250 and the ASIC 216 via the PCI bus.

A facsimile control unit (FCU) 230 and a connection device 240 are connected to the ASIC 216 via the PCI bus. The connection device 240 may include interfaces such as a universal serial bus (USB) interface and an Institute of Electrical and Electronics Engineers 1394 (IEEE 1394) interface. A control panel 220 is directly connected to the ASIC 216.

The local memory 217 is used as a copy image buffer and a code buffer. The HDD 218 is a storage device for storing image data, programs, font data, and forms.

The AGP bus 215 is a bus interface for a graphics accelerator card, which has been proposed to accelerate graphics processing. The AGP bus 215 directly accesses the system memory 212 with high throughput to accelerate the graphics accelerator card.

The lifetime prediction device 10 according to the present embodiment predicts the remaining lifetime of a target object using the lifetime calculation model generated based on information such as the operation information of the target object and the event information pertaining to an event that has caused replacement of the target object, as in the first embodiment. The operation information includes characteristic values during operation for each target object and environmental values indicating the environment around the target object. The characteristic values may include a printed sheet counter value indicating the number of sheets printed by the image forming apparatus 40 and an index indicating a print frequency, but are not limited thereto.

The lifetime prediction device 10 according to the present embodiment enhances the prediction accuracy of the remaining lifetime of the image forming apparatus 40 and the components of the image forming apparatus 40.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc-read-only memory (CD-ROM) or digital versatile disk (DVD), and/or the memory of an FPGA or ASIC.

A description is given below of several aspects of the present disclosure.

According to a first aspect, a lifetime prediction device includes an acquisition unit and a prediction unit. The acquisition unit acquires operation information, initial information, and event information. The operation information indicates an operating status of a target object, which includes an electronic device and a component of the electronic device. The operation information includes a characteristic value during operation for each target object and an environment value indicating an environment around the target object. The initial information includes an initial value of the characteristic value of the target object. The event information pertains to an event that has caused replacement of the target object. The prediction unit predicts a remaining lifetime of the target object based on the characteristic value included in the operation information, the initial value of the characteristic value included in the initial information, and the characteristic value at the replacement of the target object.

According to a second aspect, in the lifetime prediction device of the first aspect, the prediction unit predicts the remaining lifetime of the target object using a lifetime calculation model that is generated to calculate a lifetime of the target object based on the operation information, the initial information, and the characteristic value at the replacement of the target object.

According to a third aspect, in the lifetime prediction device of the second aspect, the prediction unit predicts the remaining lifetime of the target object using the lifetime calculation model that is modeled by applying a Weibull distribution to the operation information, the initial information, and the characteristic value at the replacement of the target object.

According to a fourth aspect, in the lifetime prediction device of the second aspect, the prediction unit predicts the remaining lifetime of the target object using the lifetime calculation model that is generated by machine learning, using the operation information, the initial information, and the characteristic value at the replacement of the target object as explanatory variables, to output the lifetime of the target object.

According to a fifth aspect, in the lifetime prediction device of any one of the second to fourth aspects, the prediction unit predicts the remaining lifetime of the target object based on the lifetime of the target object calculated using the lifetime calculation model and an average lifetime of the target object.

According to a sixth aspect, the lifetime prediction device of any one of the second to fifth aspects further includes a determination unit to determine whether the target object is reusable based on the remaining lifetime of the target object and a lifetime prediction threshold of the target object.

According to a seventh aspect, in the lifetime prediction device of any one of the second to sixth aspects, information included in the operation information, the initial information, and the event information of the target object is associated with identification information for identifying the target object.

According to an eighth aspect, in the lifetime prediction device of any one of the second to seventh aspects, the target object includes at least one of an image forming apparatus and a component included in the image forming apparatus.

According to a ninth aspect, a lifetime prediction method executed by a lifetime prediction device includes an acquiring step and a predicting step. The acquiring step includes acquiring operation information, initial information, and event information. The operation information indicates an operating status of a target object, which includes an electronic device and a component of the electronic device. The operation information includes a characteristic value during operation for each target object and an environment value indicating an environment around the target object. The initial information includes an initial value of the characteristic value of the target object. The event information pertains to an event that has caused replacement of the target object. The predicting step includes predicting a remaining lifetime of the target object based on the characteristic value included in the operation information, the initial value of the characteristic value included in the initial information, and the characteristic value at the replacement of the target object.

According to a tenth aspect, a program causes a computer to execute acquiring and predicting. The acquiring includes acquiring operation information, initial information, and event information. The operation information indicates an operating status of a target object, which includes an electronic device and a component of the electronic device. The operation information includes a characteristic value during operation for each target object and an environment value indicating an environment around the target object. The initial information includes an initial value of the characteristic value of the target object. The event information pertains to an event that has caused replacement of the target object. The predicting includes predicting a remaining lifetime of the target object based on the characteristic value included in the operation information, the initial value of the characteristic value included in the initial information, and the characteristic value at the replacement of the target object.

1. A lifetime prediction device, comprising circuitry configured to:
acquire:
operation information indicating an operating status of a target object, the target object including an electronic device and a component of the electronic device,
the operation information including a characteristic value during operation of the target object and an environment value indicating an environment around the target object;
initial information including an initial value of the characteristic value of the target object; and
event information pertaining to an event that has caused replacement of the target object; and
predict a remaining lifetime of the target object based on the characteristic value included in the operation information, the initial value of the characteristic value included in the initial information, and the characteristic value at the replacement of the target object.

2. The lifetime prediction device according to claim 1, wherein the circuitry is configured to predict the remaining lifetime of the target object using a lifetime calculation model, the lifetime calculation model being generated to calculate a lifetime of the target object based on the operation information, the initial information, and the characteristic value at the replacement of the target object.

3. The lifetime prediction device according to claim 2, wherein the lifetime calculation model is modeled by applying a Weibull distribution to the operation information, the initial information, and the characteristic value at the replacement of the target object.

4. The lifetime prediction device according to claim 2, wherein the lifetime calculation model is generated by machine learning, using the operation information, the initial information, and the characteristic value at the replacement of the target object as explanatory variables, to output the lifetime of the target object.

5. The lifetime prediction device according to claim 2, wherein the circuitry is configured to predict the remaining lifetime of the target object based on the lifetime of the target object calculated using the lifetime calculation model and an average lifetime of the target object.

6. The lifetime prediction device according to claim 1, wherein the circuitry is further configured to determine whether the target object is reusable based on the remaining lifetime of the target object and a lifetime prediction threshold of the target object.

7. The lifetime prediction device according to claim 1, wherein the operation information, the initial information, and the event information of the target object are associated with identification information for identifying the target object.

8. The lifetime prediction device according to claim 1, wherein the target object includes at least one of an image forming apparatus or a component included in the image forming apparatus.

9. A lifetime prediction method, comprising:
acquiring:
operation information indicating an operating status of a target object, the target object including an electronic device and a component of the electronic device,
the operation information including a characteristic value during operation of the target object and an environment value indicating an environment around the target object;
initial information including an initial value of the characteristic value of the target object; and
event information pertaining to an event that has caused replacement of the target object; and
predicting a remaining lifetime of the target object based on the characteristic value included in the operation information, the initial value of the characteristic value included in the initial information, and the characteristic value at the replacement of the target object.

10. A non-transitory recording medium storing a plurality of instructions which, when executed by one or more processors, causes the one or more processors to perform a lifetime prediction method, the method comprising:
acquiring:
operation information indicating an operating status of a target object, the target object including an electronic device and a component of the electronic device,
the operation information including a characteristic value during operation of the target object and an environment value indicating an environment around the target object;
initial information including an initial value of the characteristic value of the target object; and
event information pertaining to an event that has caused replacement of the target object; and
predicting a remaining lifetime of the target object based on the characteristic value included in the operation information, the initial value of the characteristic value included in the initial information, and the characteristic value at the replacement of the target object.
